(19) United States
(12) Patent Application Publication
(10) Pub. No.: US 2022/0144292 A1
(43) Pub. Date: May 12, 2022

(54) SYSTEMS AND METHODS FOR SELECTING A USER PROFILE AMONG MULTIPLE USERS CARRYING PERSONAL DEVICES

(71) Applicants: Toyota Motor North America, Inc., Plano, TX (US); Toyota Jidosha Kabushiki Kaisha, Toyota-shi Aichi-ken (JP)

(72) Inventors: Anil Nagpal, Plano, TX (US); Yuho Kozu, Dallas, TX (US); Nitesh Kumar, Plano, TX (US); Masanori Kushibe, Toyota-shi (JP); Tomonari Yamaguchi, Toyota-shi (JP)

(73) Assignees: Toyota Motor North America, Inc., Plano, TX (US); Toyota Jidosha Kabushiki Kaisha, Toyota-shi (JP)

(21) Appl. No.: 17/092,993

(22) Filed: Nov. 9, 2020

(51) Int. Cl. B60W 50/00; H04W 4/80; H04W 4/48; B60R 16/037

(52) U.S. Cl. CPC B60W 50/0098; H04W 4/80; B60W 2540/215; B60R 16/037; B60W 2540/047; H04W 4/48

(57) ABSTRACT

A method comprises, upon determination that one user profile is associated with a detected one or more mobile devices, loading the one user profile associated with the detected one or more mobile devices, upon determination that a plurality of user profiles are associated with the detected one or more mobile devices, loading the user profile that was most recently loaded on the vehicle, and upon determination that no user profiles are associated with the detected one or more mobile devices, loading a guest profile.

### TECHNICAL FIELD

The present specification relates to driver assistance systems, and more particularly, to systems and methods for selecting a user profile among multiple users carrying personal devices.

### BACKGROUND

Vehicles may have a number of settings that drivers may adjust based on their personal preferences. For example, these settings may include seat positions, mirror positions, pedal positions, radio station presets, heating and air conditioning settings, navigation settings, voice settings, audio settings, search settings, subscription status, screen configurations, and the like. A vehicle may store parameters for one or more of these settings in a user profile associated with a driver. Then, when the driver enters a vehicle, the vehicle settings may be automatically adjusted to the user's preferences based on the user profile. Thus, a driver need not manually adjust these settings each time he enters the vehicle.

If multiple drivers use a particular vehicle, the vehicle may store a user profile for each such driver. As such, when a particular driver uses the vehicle, it may be desirable for the vehicle to load a user profile associated with that driver and adjust the vehicle settings according to the user profile.

When a driver enters a vehicle, the vehicle may detect a mobile device (e.g., a smartphone) carried by the driver. The vehicle may identify the driver based on the detected mobile device and automatically load a user profile associated with that driver. This may increase the convenience of the driver by obviating the need for the driver to manually select a user profile. However, if multiple individuals enter a vehicle (e.g., a driver and one or more passengers) and each individual carries a mobile device that can be detected by the vehicle and is associated with a user profile, the vehicle may not know which individual is the driver. Consequently, the vehicle may not be able to load the appropriate user profile for the individual who is driving the vehicle. Accordingly, there is a need for systems and methods for selecting a user profile among multiple users carrying personal devices.

### SUMMARY

In one embodiment, upon determination that one user profile is associated with a detected one or more mobile devices, the one user profile associated with the detected one or more mobile devices is loaded. Upon determination that a plurality of user profiles are associated with the detected one or more mobile devices, the user profile that was most recently loaded on a vehicle is loaded. Upon determination that no user profiles are associated with the detected one or more mobile devices, a guest profile is loaded.

In another embodiment, a vehicle system for a vehicle includes one or more processors and a controller. The controller is configured to detect one or more mobile devices and determine whether one or more user profiles are associated with the detected one or more mobile devices. Upon determination that one user profile is associated with the detected one or more mobile devices, the controller loads that user profile. Upon determination that a plurality of user profiles are associated with the detected one or more mobile devices, the controller determines which user profile of the plurality of user profiles was most recently loaded on the vehicle and loads that user profile. Upon determination that no user profiles are associated with the detected one or more mobile devices, the controller loads a guest profile.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 depicts an example system for selecting a user profile among multiple users carrying a personal device, according to one or more embodiments shown and described herein;

FIG. 2 depicts a schematic diagram of an example vehicle system, according to one or more embodiments shown and described herein;

FIG. 3 depicts a schematic diagram of exemplary memory modules of the vehicle system of FIG. 2, according to one or more embodiments shown and described herein;

FIG. 4 depicts a flow chart of an example method of selecting a user profile among multiple users carrying a personal device, according to one or more embodiments shown and described herein; and

FIG. 5 depicts a timing diagram for selecting a user profile among multiple users carrying a personal device, according to one or more embodiments shown and described herein.

### DETAILED DESCRIPTION

The embodiments disclosed herein include systems and methods for selecting a user profile among multiple users carrying personal (e.g., mobile) devices. One or more users may enter a vehicle. Each users may carry a mobile device, such as a smartphone. Each mobile device may have an ID that may be detected by a vehicle system of the vehicle. Furthermore, each mobile device ID may be associated with a user profile. Each user profile may be associated with the user carrying the corresponding mobile device and may comprise a series of vehicle settings preferred by a particular user.

When the vehicle system detects multiple mobile devices associated with multiple user profiles, the vehicle system must determine which user profile to load. Disclosed herein are rules that the vehicle system may follow to determine which user profile to load. In particular, the vehicle system may determine which user profile associated with a detected mobile device was most recently loaded (e.g., during a previous driving trip) and load that profile. As such, the vehicle system is more likely to load the user profile associated with the driver of the vehicle. For example, if a driver and a passenger drive a certain distance and then stop for gas, it is more likely that the same person will continue to drive the vehicle when the driving trip is resumed. If no mobile devices are detected that are associated with a known user profile, then the vehicle system may load a guest profile.

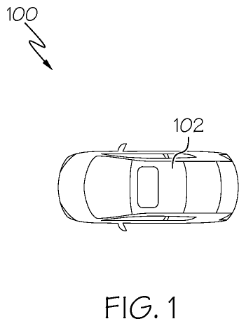

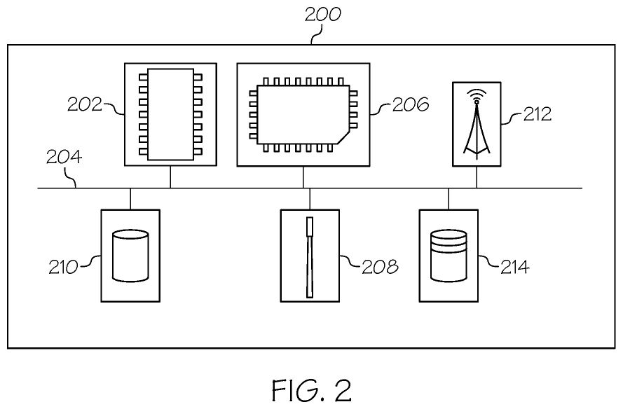

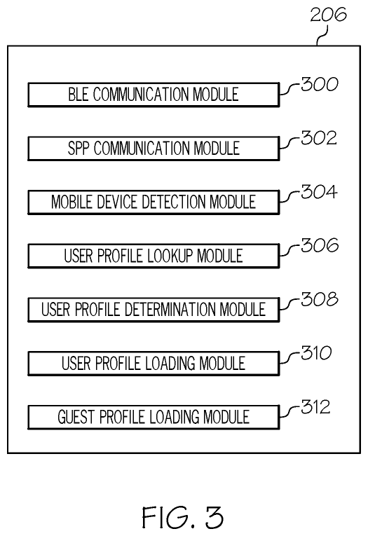

FIG. 1 depicts an example system 100 for selecting a user profile among multiple users carrying personal devices. The system 100 includes a vehicle 102 having a vehicle system 200 (see FIG. 2). The vehicle 102 may include a head unit (not shown) that may be used to select a user profile using the techniques described herein. The vehicle system 200 is discussed in further detail in connection with FIGS. 2 and 3.

FIG. 2 depicts an example vehicle system 200 included in the vehicle 102 of FIG. 1. The vehicle system 200 includes one or more processors 202, a communication path 204, one or more memory modules 206, a transceiver 208, one or more vehicle sensors 210, network interface hardware 212, and a data storage component 214, the details of which will be set forth in the following paragraphs. In examples where the vehicle 102 is an autonomous vehicle, the vehicle system 200 may also include one or more modules for performing autonomous driving of the vehicle 102. It should be understood that the vehicle system 200 of FIG. 2 is provided for illustrative purposes only, and that other vehicle systems 200 comprising more, fewer, or different components may be utilized.

Each of the one or more processors 202 may be any device capable of executing machine readable and executable instructions. Accordingly, each of the one or more processors 202 may be a controller, an integrated circuit, a microchip, a computer, or any other computing device. The one or more processors 202 are coupled to a communication path 204 that provides signal interconnectivity between various modules of the vehicle system 200. Accordingly, the communication path 204 may communicatively couple any number of processors 202 with one another, and allow the modules coupled to the communication path 204 to operate in a distributed computing environment. Specifically, each of the modules may operate as a node that may send and/or receive data. As used herein, the term “communicatively coupled” means that coupled components are capable of exchanging data signals with one another such as, for example, electrical signals via conductive medium, electromagnetic signals via air, optical signals via optical waveguides, and the like.

Accordingly, the communication path 204 may be formed from any medium that is capable of transmitting a signal such as, for example, conductive wires, conductive traces, optical waveguides, or the like. In some embodiments, the communication path 204 may facilitate the transmission of wireless signals, such as WiFi, Bluetooth®, Near Field Communication (NFC) and the like. Moreover, the communication path 204 may be formed from a combination of mediums capable of transmitting signals. In one embodiment, the communication path 204 comprises a combination of conductive traces, conductive wires, connectors, and buses that cooperate to permit the transmission of electrical data signals to components such as processors, memories, sensors, input devices, output devices, and communication devices. Accordingly, the communication path 204 may comprise a vehicle bus, such as for example a LIN bus, a CAN bus, a VAN bus, and the like. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium.

The vehicle system 200 includes one or more memory modules 206 coupled to the communication path 204. The one or more memory modules 206 may comprise RAM, ROM, flash memories, hard drives, or any device capable of storing machine readable and executable instructions such that the machine readable and executable instructions can be accessed by the one or more processors 202. The machine readable and executable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine readable and executable instructions and stored on the one or more memory modules 206. Alternatively, the machine readable and executable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components. The memory modules 206 of the vehicle system 200 are described in further detail below with respect to FIG. 3. In embodiments, a combination of the one or more processors 202 and one or more memory modules 206 constitutes a controller for the vehicle system 200. In embodiments, one or more of the components of the vehicle system 200 may be included in a head unit coupled to the vehicle 102.

Referring still to FIG. 2, the example vehicle system 200 comprises a transceiver 208 coupled to the communication path 204 such that the communication path 204 communicatively couples the transceiver 208 to other modules of the vehicle system 200. The transceiver 208 is configured to establish communication between the vehicle system 200 and one or more mobile devices within the vehicle 102, as described herein. As such, the transceiver 208 may send and receive signals to and from one or more mobile devices. In the illustrated example, the transceiver 208 communicates with mobile devices using the Bluetooth® communication protocol. In other examples, the transceiver 208 may communicate with mobile devices using any other suitable communication protocol. In the illustrated example, the transceiver 208 may communicate with mobile devices using the Bluetooth® Serial Port Profile (SPP) and the Bluetooth® Low Energy (BLE) communication profiles, as described in further detail below. In other examples, the vehicle system 200 may comprise one transceiver for communicating with mobile devices using the Bluetooth® SPP protocol and another transceiver for communicating with mobile devices using the BLE protocol.

The vehicle system 200 comprises one or more vehicle sensors 210. Each of the one or more vehicle sensors 210 is coupled to the communication path 204 and communicatively coupled to the one or more processors 202. The one or more vehicle sensors 210 may include, but are not limited to, LiDAR sensors, RADAR sensors, optical sensors (e.g., cameras, laser sensors, proximity sensors, location sensors), and the like. In some examples, the vehicle sensors 210 may be used to autonomously navigate the vehicle 102.

Still referring to FIG. 2, the vehicle system 200 comprises network interface hardware 212 for communicatively coupling the vehicle system 200 to external devices (e.g., a server to provide navigation or other services). The network interface hardware 212 can be communicatively coupled to the communication path 204 and can be any device capable of transmitting and/or receiving data via a network. Accordingly, the network interface hardware 212 can include a communication transceiver for sending and/or receiving any wired or wireless communication. For example, the network interface hardware 212 may include an antenna, a modem, LAN port, Wi-Fi card, WiMax card, mobile communications hardware, near-field communication hardware, satellite communication hardware and/or any wired or wireless hardware for communicating with other networks and/or devices. In one embodiment, the network interface hardware 212 includes hardware configured to operate in accordance with the Bluetooth® wireless communication protocol.

Still referring to FIG. 2, the vehicle system 200 comprises a data storage component 214. The data storage component 214 may store data that may be utilized by the memory modules 206 and/or other components of the vehicle system 200. For example, the data storage component 214 may store user profiles associated with one or more users. A user profile associated with a user may comprise preferences for the user for one or more settings of components associated with the vehicle 102.

Now referring to FIG. 3, exemplary memory modules 206 of the vehicle system 200 are shown. The one or more memory modules 206 include a BLE communication module 300, an SPP communication module 302, a mobile device detection module 304, a user profile lookup module 306, a user profile determination module 308, a user profile loading module 310, and a guest profile loading module 312. Each of the BLE communication module 300, the SPP communication module 302, the mobile device detection module 304, the user profile lookup module 306, the user profile determination module 308, the user profile loading module 310, and the guest profile loading module 312 may be a program module in the form of operating systems, application program modules, and other program modules stored in the one or more memory modules 206. Such a program module may include, but is not limited to, routines, subroutines, programs, objects, components, data structures and the like for performing specific tasks or executing specific data types as will be described below.

The BLE communication module 300 may establish BLE communication with one or more mobile devices using the BLE protocol. Specifically, the BLE communication module 300 may cause the transceiver 208 to broadcast a BLE signal that may be detected by mobile devices located inside or near the vehicle 102. When a mobile device receives the BLE broadcast signal, a communication channel may be established between the BLE communication module 300 and the mobile device by pairing the mobile device to the BLE communication module 300 using the BLE protocol.

In embodiments, a mobile device may run an appropriate application (e.g., an application compatible with the system 100) so that the mobile device may be paired with the BLE communication module 300. By using the BLE protocol, the BLE communication module 300 may pair with a mobile device even if the mobile device has not previously been paired with the vehicle system 200. Once a mobile device is paired to the BLE communication module 300, data may be transmitted between the BLE communication module 300 and the mobile device via the transceiver 208.

The SPP communication module 302 may establish SPP communication with a mobile device using the SPP protocol. However, unlike the BLE protocol, the SPP protocol can only be used to pair with a mobile device that has been previously paired to the vehicle system 200. Accordingly, the SPP communication module 302 may cause the transceiver 208 to ping for mobile devices that have previously been paired to the SPP communication module 302. When a mobile device responds to a ping from the SPP communication module 302, a communication channel may be established between the SPP communication module 302 and the mobile device by pairing the mobile device to the SPP communication module 302 using the SPP protocol. Once a mobile device is paired to the SPP communication module 302, data may be transmitted between the SPP communication module 302 and the mobile device via the transceiver 208.

The mobile device detection module 304 may detect one or more mobile devices positioned within or in the vicinity of the vehicle 102. Specifically, after a mobile device is paired to either the BLE communication module 300 or the SPP communication module 302, the mobile device detection module 304 may determine a device ID associated with the paired mobile device. In embodiments, each mobile device that is able to pair with the BLE communication module 300 and/or the SPP communication module 302 (e.g., each mobile device running an application associated with the system 100) has a device ID that uniquely identifies the mobile device. Accordingly, the device ID of a paired mobile device may be detected by the mobile device detection module 304 to identify the paired mobile device. Furthermore, each device ID may be associated with a particular user profile associated with an owner or user of the mobile device having the device ID. As such, a device ID of a mobile device may be used to determine a user profile associated with a particular user.

In embodiments, one or more user profiles associated with one or more device IDs may be stored in the data storage component 214. As discussed above, each user profile may comprise settings for one or more components of the vehicle 102 preferred by a user associated with the user profile. The settings of the user profile may be stored in the data storage component 214. In some examples, a user may establish a user profile using a head unit of the vehicle 102. In some examples, a user may establish a user profile using a mobile device. In other examples, a user may establish a user profile using other methods and/or devices. In some embodiments, one or more user profiles may be stored in a remote server, and the vehicle system 200 may receive the one or more user profiles from the remote server when corresponding profiles needed to be loaded on the vehicle system 200.

Referring still to FIG. 3, the user profile lookup module 306 may look up a user profile associated with a particular device ID. That is, after a mobile device is paired to either the BLE communication module 300 or the SPP communication module 302 and the mobile device detection module 304 determines the device ID of the paired mobile device, the user profile lookup module 306 may access the data storage component 214 and determine whether a user profile exists that is associated with the determined device ID. If a user profile has been established for the user associated with a detected device ID, then that user profile will be stored in the data storage component 214 and the user profile lookup module 306 may access that user profile. Alternatively, if no user profile exists for the detected device ID, then no user profile associated with the detected device ID will be stored in the data storage component 214 and the user profile determination module 308 will be unable to access a user profile associated with the detected device ID. If multiple mobile devices are detected by the mobile device detection module 304, the user profile lookup module 306 may determine whether a user profile associated with each such mobile device exists and may access each existing user profile.

In addition to storing user profiles associated with device IDs, the data storage component 214 may also maintain a profile log comprising user profiles previously loaded by the vehicle system 200. This log may include a timestamp when each user profile was loaded. Every time that a user profile is loaded, the log may be updated. This log may be used by the vehicle system 200, as explained in further detail below.

Referring still to FIG. 3, the user profile determination module 308 determines which user profile to load after one or more mobile devices are detected by the mobile device detection module 304. If a single mobile device is detected by the mobile device detection module 304, and the user profile lookup module 306 is able to access a user profile associated with the device ID of the detected mobile device, then the user profile determination module 308 may determine that the user profile associated with the detected mobile device should be loaded. This situation may occur when a single individual enters the vehicle 102 carrying a mobile device associated with a user profile. In this situation, the sole detected individual will likely drive the vehicle 102 and the user profile determination module 308 determines that the user profile associated with the individual is to be loaded.

Alternatively, if a single mobile device is detected by the mobile device detection module 304 but the user profile lookup module 306 is unable to find a user profile associated with the device ID of the detected mobile device, then the user profile determination module 308 may determine that a guest profile should be loaded. A guest profile may comprise default settings for one or more components of the vehicle 102 that may be loaded when an individual driving the vehicle 102 has not established a user profile. A guest profile may be stored in the data storage component 214. This situation may occur when a single individual enters the vehicle 102 carrying a mobile device that is not associated with a user profile. In this situation, the sole detected individual will likely drive the vehicle but has not previously established a user profile. Accordingly, the user profile determination module 308 may determine that a guest user profile is to be loaded.

In examples where the mobile device detection module 304 detects multiple mobile devices, there may be multiple user profiles associated with the multiple mobile devices. As such, the user profile determination module 308 may determine which user profile to load using the techniques described herein. If the mobile device detection module 304 detects multiple mobile devices, the user profile lookup module 306 determines whether the data storage component 214 contains a user profile associated with the device ID of each of the detected mobile devices. If the user profile lookup module 306 determines that the data storage component 214 does not contain user profiles for any of the detected mobile devices, then the user profile determination module 308 determines that the guest profile should be loaded. If instead, the user profile lookup module 306 determines that the data storage component 214 contains a user profile for exactly one of the detected mobile devices, then the user profile determination module 308 determines that the user profile associated with the detected mobile device should be loaded. Alternatively, if the user profile lookup module 306 determines that the data storage component 214 contains user profiles for a plurality of the detected mobile devices, the user profile determination module 308 may use the techniques described below to determine which user profile to load.

When the user profile lookup module 306 determines that the data storage component 214 contains user profiles for a plurality of the detected mobile devices, the user profile determination module 308 may access the profile log stored in the data storage component 214. As discussed above, the profile log records a record each time that a user profile is loaded. Accordingly, after accessing the profile log, the user profile determination module 308 may determine which of the user profiles associated with the detected mobile devices was most recently loaded. The user profile determination module 308 may then determine that the user profile among the user profiles associated with the detected mobile devices that was most recently loaded should be loaded. In particular, the user profile determination module 308 may review the user profiles in the profile log in reverse order of when they were loaded, starting with the most recently loaded user profile. Once a previously loaded user profile associated with a device ID that matches the device ID of one of the detected mobile devices is found, the user profile determination module 308 may select that user profile (i.e., the most recently loaded user profile) to be loaded.

By loading the most recently loaded user profile, it may be more likely that the user profile determination module 308 selects the user profile associated with the person who will actually be driving the vehicle 102. For example, if a driver and a passenger, who each have separate user profiles, get in a vehicle and start driving, the user profile of the driver may be loaded; either automatically by the vehicle system 200 using the techniques described herein or by the driver manually selecting his user profile. If the vehicle is then stopped and turned off (e.g., at a gas station, a restaurant, etc.), when the vehicle is started again, a user profile will once again have to be loaded. If the same driver and passenger then get in the vehicle again, it is presumed to be more likely that the same person will be driving who was driving before the vehicle was stopped. Accordingly, because the user profile of the previous driver was more recently loaded, if the same person continues to drive the vehicle 102, the same user profile is automatically determined as the user profile to be loaded by the user profile determination module 308. This may allow the correct user profile to be automatically loaded without any action needing to be taken by the driver. In the event that the incorrect user profile is loaded, the actual driver may manually select the correct user profile to be loaded.

A table below is an exemplary set of rules for determining which profile should be loaded on the head unit.

Profile identified

| Primary | Secondary | Secondary | | Secondary | |
|---|---|---|---|---|---|
| user | user 1 | user 2 | ... | user n | Profile to be loaded on head unit |
| No | No | No | | No | Guest |
| Yes | No | No | | No | Primary user |
| No | Yes | No | | No | Secondary user 1 |
| No | No | Yes | | No | Secondary user 2 |
| No | No | No | | Yes | Secondary user n |
| Yes | Yes | No | | No | Primary user or Secondary user 1 |
| | | | | | whichever was loaded last time |
| Yes | No | Yes | | No | Primary user or Secondary user 2 |
| | | | | | whichever was loaded last time |
| Yes | No | No | | Yes | Primary user or Secondary user n |
| | | | | | whichever was loaded last time |
| No | Yes | Yes | | No | Secondary user 1 or Secondary user 2 |
| | | | | | whichever was loaded last time |
| No | Yes | No | | Yes | Secondary user 1 or Secondary user n |
| | | | | | whichever was loaded last time |
| No | Yes | Yes | | Yes | Secondary user 1, 2, or n whichever |
| | | | | | was loaded last time |
| Yes | Yes | Yes | | Yes | Primary user or Secondary user 1, 2, or |
| | | | | | n whichever was loaded last time |

For example, if the user profile for Primary user and the user profile for Secondary user 1 are identified, then the head unit may load a profile for Primary user or Secondary user 1 whichever was loaded last time. That is, if the user profile for Secondary user 1 was loaded last time, then, the head unit loads the user profile for Secondary user 1 instead of the user profile for Primary user. As another example, if the user profile for Primary user, the user profile for Secondary user 1 and the user profile for Secondary user 2 are identified, then the head unit may load a profile for Primary user, Secondary user 1, or Secondary user 2 whichever was loaded last time. Any profile can be automatically loaded based on the matrix above.

Referring still to FIG. 3, the user profile loading module 310 may load the user profile selected by the user profile determination module 308 stored in the data storage component 214. This may cause the vehicle settings associated with the selected user profile to be implemented by the vehicle 102. In addition, after the user profile loading module 310 loads a user profile, the user profile loading module 310 may update the profile log in the data storage component 214 to indicate the selected user profile was loaded. Accordingly, the profile log will be up to date the next time the vehicle system needs to determine which user profile to load.

The guest profile loading module 312 may load the guest profile stored in the data storage component 214 when the user profile determination module 308 determines that the guest profile should be loaded. This may cause the vehicle settings associated with the guest user profile to be implemented by the vehicle 102. In some examples, a user may adjust the default vehicle settings associated with the guest profile.

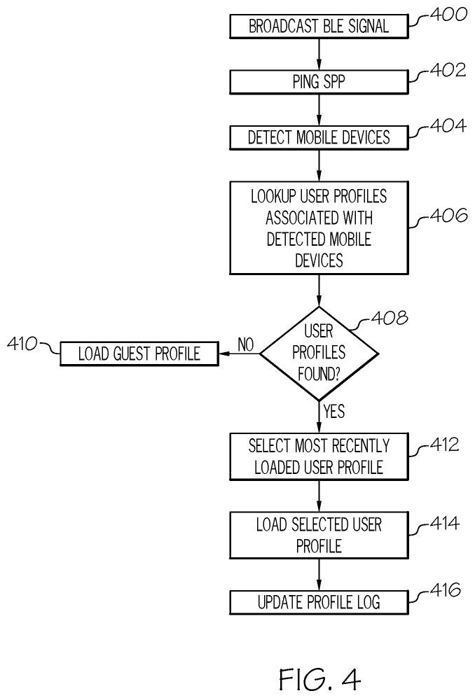

FIG. 4 depicts a flowchart of an example method for operating the example vehicle system 200, according to one or more embodiments shown and described herein. At step 400, the BLE communication module 300 causes the transceiver 208 to broadcast a BLE signal that may be detected by one or more mobile devices. At step 402, the SPP communication module 302 may cause the transceiver 208 to ping for mobile devices that have been previously paired to the SPP communication module 302. The transceiver 208 may simultaneously emit the BLE broadcast signal and the SPP ping signal. As such, the vehicle system 200 may simultaneously attempt to establish communication with mobile devices using both the BLE protocol and the SPP protocol. In some examples, steps 400 and 402 occur every time that the vehicle 102 is started. In other examples, the steps 400 and 402 may occur at other timings.

At step 404, the mobile device detection module 304 detects one or more devices within or near the vehicle 102. The mobile device detection module 304 may detect mobile devices that have been paired to either the BLE communication module 300 or the SPP communication module 302. The mobile device detection module 304 may also determine a device ID associated with each detected mobile device.

At step 406, the user profile lookup module 306 attempts to look up user profiles associated with each of the device IDs of the detected mobile devices in the data storage component 214. Specifically, the user profile lookup module 306 determines whether the data storage component 214 contains a user profile associated with each of the detected device IDs.

At step 408, the user profile determination module 308 determines, for each of the detected device IDs, whether the data storage component 214 contains a stored user profile for the device ID. If the user profile lookup module 306 is unable to find a user profile associated with any of the detected device IDs (no at step 408), then in step 410, the guest profile loading module 310 loads the guest profile. Alternatively, if the user profile lookup module 306 is able to find one or more user profiles associated with one or more of the detected device IDs (yes at step 408), then control passes to step 412.

At step 412, the user profile determination module 308 determines which of the user profiles associated with the detected device IDs was most recently loaded by the user profile loading module 310 and selects that user profile to be loaded. Then, at step 414, the user profile loading module 310 loads the user profile selected by the user profile determination module 308. At step 416, after the selected user profile is loaded, the user profile loading module 310 may update the profile log in the data storage component 214 with a new record indicating that the selected user profile was loaded and the timestamp at which it was loaded.

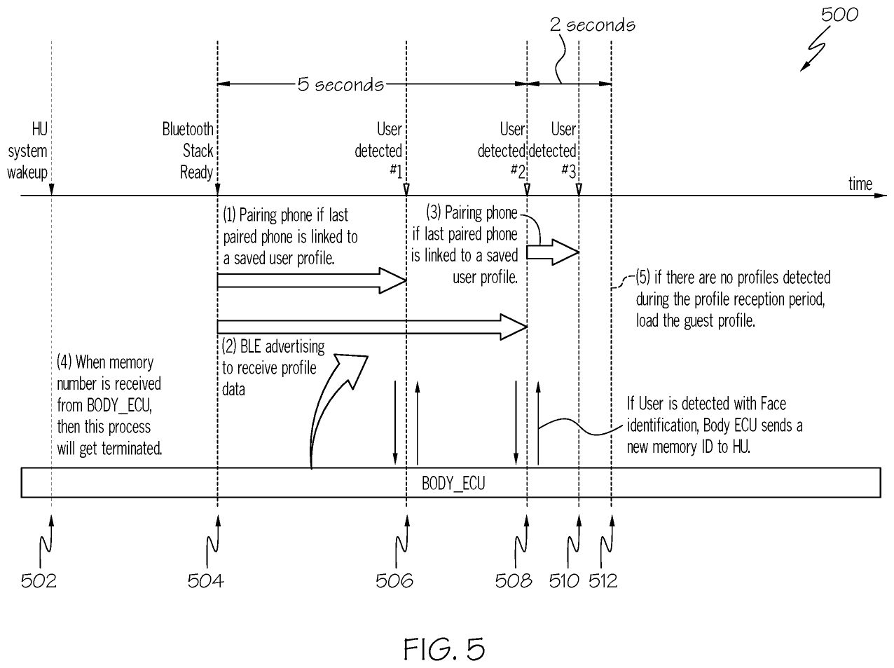

Referring now to FIG. 5, a timing diagram 500 is shown for an example operation of the vehicle system 200. The example of FIG. 5 begins at timing 502 when a head unit of the vehicle 102 wakes up (e.g., when the vehicle 102 is started). At timing 504, the SPP communication module 302 attempts to pair to a previously paired mobile device and the BLE communication module 300 begins BLE broadcasting or advertising.

In the example of FIG. 5, at timing 506, a first user is detected by the SPP communication module 302 and the first user's mobile device is paired to the SPP communication module 302. At timing 508, a second user is detected by the BLE communication module 300 and at timing 510, a third user is detected by the BLE communication module 300. The user profile lookup module 306 attempts to look up user profiles associated with the detected mobile devices and the user profile determination module 308 determines which user profile to load using the techniques described above. At timing 512, the BLE communication module 300 and the SPP communication module 302 stop looking for mobile devices. As shown in the example of FIG. 5, a profile reception period during which the BLE communication module 300 and the SPP communication module 302 look for mobile devices is 7 seconds. However, in other examples, the profile reception period may comprise other lengths of time.

In the example of FIG. 5, an electronic control unit of the vehicle 102 (referred to as BODY_ECU in FIG. 5) may detect a user in the vehicle with face identification or other methods. If a user is detected in this manner, the BODY_ECU may send the device ID associated with the detected user to the head unit.

It should now be understood that embodiments described herein are directed to systems and methods for selecting a user profile among multiple users carrying personal devices. A vehicle system may detect one or more mobile devices within or near a vehicle. When one or more devices are detected, the vehicle system may determine a device ID associated with each detected mobile device and determine whether a stored user profile is associated with each of the detected mobile devices. If a single stored user profile is associated with one of the detected mobile devices, the vehicle system may load that user profile. If multiple profiles are associated with multiple detected mobile devices, the vehicle system may load the user profile associated with the detected mobile devices that was most recently loaded by the vehicle system. If no user profiles are associated with any of the detected mobile devices, the vehicle system may load a guest profile.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method comprising:
upon determination that one user profile is associated with a detected one or more mobile devices, loading the one user profile associated with the detected one or more mobile devices;
upon determination that a plurality of user profiles are associated with the detected one or more mobile devices, loading the user profile that was most recently loaded on a vehicle; and
upon determination that no user profiles are associated with the detected one or more mobile devices, loading a guest profile.

2. The method of claim 1, wherein each of the one user profile, the plurality of user profiles, and the guest profile comprises one or more settings preferred by a user associated with one or more components of the vehicle.

3. The method of claim 1, wherein the guest profile comprises one or more default settings associated with one or more components of the vehicle.

4. The method of claim 1, further comprising:
detecting the one or more mobile devices using Bluetooth communication protocol.

5. The method of claim 1, further comprising:
detecting the one or more mobile devices using Bluetooth Low Energy communication.

6. The method of claim 1, further comprising:
detecting the one or more mobile devices using Bluetooth Serial Port Profile communication.

7. The method of claim 1, further comprising:
detecting the one or more mobile devices by simultaneously broadcasting a Bluetooth Low Energy signal and attempting to connect to a mobile device that was previously paired to a vehicle system using Bluetooth Serial Port Profile communication.

8. The method of claim 1, further comprising:
determining a device ID associated with each of the detected one or more mobile devices; and
determining one or more user profiles associated with the device IDs of the detected one or more mobile devices.

9. The method of claim 1, further comprising:
upon determination that the plurality of user profiles are associated with the detected one or more mobile devices, accessing a profile log to determine which user profile of the plurality of user profiles was most recently loaded, the profile log comprising records of previous times that user profiles were loaded on the vehicle.

10. The method of claim 9, further comprising:
after loading a user profile associated with a detected mobile device, updating the profile log based on the user profile that was loaded.

11. A vehicle system for a vehicle comprising:
one or more vehicle sensors; and
a controller configured to:
detect one or more mobile devices;
determine whether one or more user profiles are associated with the detected one or more mobile devices;
upon determination that one user profile is associated with the detected one or more mobile devices, load the one user profile associated with the detected one or more mobile devices;
upon determination that a plurality of user profiles are associated with the detected one or more mobile devices, determine which user profile of the plurality of user profiles was most recently loaded on the vehicle, and load the user profile that was most recently loaded on the vehicle; and
upon determination that no user profiles are associated with the detected one or more mobile devices, load a guest profile.

12. The vehicle system of claim 11, wherein each of the one user profile, the plurality of user profiles, and the guest profile comprises one or more settings preferred by a user associated with one or more components of the vehicle.

13. The vehicle system of claim 11, wherein the guest profile comprises one or more default settings associated with one or more components of the vehicle.

14. The vehicle system of claim 11, wherein the controller is configured to:
detect the one or more mobile devices using Bluetooth communication protocol.

15. The vehicle system of claim 11, wherein the controller is configured to:
detect the one or more mobile devices using Bluetooth Low Energy communication.

16. The vehicle system of claim 11, wherein the controller is configured to:
detect the one or more mobile devices using Bluetooth Serial Port Profile communication.

17. The vehicle system of claim 11, wherein the controller is configured to:
detect the one or more mobile devices by simultaneously broadcasting a Bluetooth Low Energy signal and attempting to connect to a mobile device that was previously paired to the vehicle system using Bluetooth Serial Port Profile communication.

18. The vehicle system of claim 11, wherein the controller is configured to:
determine a device ID associated with each of the detected one or more mobile devices; and
determine one or more user profiles associated with the device IDs of the detected one or more mobile devices.

19. The vehicle system of claim 11, wherein the controller is configured to:
upon determination that a plurality of user profiles are associated with the detected one or more mobile devices, access a profile log to determine which user profile of the plurality of user profiles was most recently loaded, the profile log comprising records of previous times that user profiles were loaded.

20. The vehicle system of claim 19, wherein the controller is configured to:
after loading a user profile associated with a detected mobile device, update the profile log based on the user profile that was loaded.
